(19) United States
(12) Patent Application Publication
(10) Pub. No.: US 2008/0309592 A1
(43) Pub. Date: Dec. 18, 2008

(54) ELECTRON SOURCE AND IMAGE-DISPLAY APPARATUS

(75) Inventors: Yasuo Ohashi, Naka-gun (JP); Hisanobu Azuma, Hadano-shi (JP); Jun Iba, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/129,070

(22) Filed: May 29, 2008

(30) Foreign Application Priority Data
Jun. 13, 2007 (JP) 2007-156389

(51) Int. Cl. G09G 3/20

(52) U.S. Cl. 345/75.2

(57) ABSTRACT

By preventing an electron-emitting device from being short-circuited when the discharge occurs, currents flown due to the short circuit are reduced to reduce effects of a discharge.

### BACKGROUND OF THE INVENTION

1. Field of the Invention

The present invention relates to an electron source and an image-display apparatus including the electron source.

2. Description of the Related Art

An electron-source substrate and a display apparatus including same are disclosed in Japanese Patent Laid-Open No. 2003-157757 (corresponding to U.S. Pat. No. 7,097,530). Particularly, when a discharge occurs at a device electrode of an electron-emitting device, a configuration disclosed in Japanese Patent Laid-Open No. 2003-157757 is useful to reduce damage to an electron-emitting device adjacent to the above-described electron-emitting device.

### SUMMARY OF THE INVENTION

The damage to the electron-emitting device adjacent to the electron-emitting device where the discharge occurs can be reduced by using technologies disclosed in Japanese Patent Laid-Open No. 2003-157757. However, a technology to further reduce the above-described damage has been demanded.

According to Japanese Patent Laid-Open No. 2003-157757, when a discharge occurs at a device electrode provided on a column wiring's side or a row wiring's side of the electron-emitting device, the electron-emitting device can be destroyed. The inventor of the present invention focused attention on how the electron-emitting device can undergo a process of destruction when the discharge occurs.

The inventor of the present invention has recognized that the following incidents occur. Namely, when the electron-emitting device where the discharge occurs is destroyed, the resistance of the electron-emitting device becomes decreased for a very short period of time (i.e., a short circuit occurs). During the short-circuit state, a current which occurs due to the discharge often flows into at least one other electron-emitting device so that the electron-emitting device becomes damaged. That is to say, a current flown in the transient state from when the discharge occurs to when the destruction of the electron-emitting device is finished may damage the at least one other electron-emitting device.

By reducing or preventing the above-described short-circuit state, electron-emitting devices other than the electron-emitting device where the discharge occurs can further be prevented from being damaged.

More specifically, the following configuration is used according to an embodiment of the present invention.

An electron source includes plural electron-emitting devices, a matrix wiring that has plural scanning wirings and plural modulation wirings and that is used to establish matrix connection between the electron-emitting devices, a first integrated circuit which applies a scan signal to the scanning wirings, so as to perform line-at-a-time driving for the electron-emitting devices, a second integrated circuit which applies a modulation signal to the modulation wirings, so as to perform line-at-a-time driving for the electron-emitting devices, and an anode which is provided at a predetermined distance from the electron-emitting devices. Each of the electron-emitting devices includes a first conductive member connected to a scanning wiring and a second conductive member connected to a modulation wiring, and the first and second conductive members are opposed to each other with a gap therebetween. According to the plural electron-emitting devices, a resistance of a region extending from part of the first conductive member facing the gap, to an output end of the first integrated circuit via a corresponding scanning wiring is RU, the resistance of a region extending from part of the second conductive member facing the gap, to an output end of the second integrated circuit via a corresponding modulation wiring is RL, and a voltage applied within the gap is Vmax. A potential generated by the first integrated circuit at an output end thereof connected to a selected scanning wiring is Vy, and a potential generated by the second integrated circuit at an output end thereof connected to a modulation wiring connected to an electron-emitting device that should emit an electron is Vx. A maximum value of a current which flows at a position of the output end of the first integrated circuit is Idis2 and a maximum value of a current which flows at the position of the output end of the second integrated circuit is Idis3 when a discharge occurs between the electron-emitting device and the anode. Consequently, the electron source includes at least one electron-emitting device satisfying the expression Idis2*RU−Idis3*RL+Vy−Vx≦Vmax.

When a discharge occurs in an electron-emitting device, other electron-emitting devices can be prevented from being damaged.

Further features of the present invention will become apparent from the following description of exemplary embodiments with reference to the attached drawings.

### BRIEF DESCRIPTION OF THE DRAWINGS

FIG. 1 shows a configuration according to an embodiment of the present invention.

FIG. 2 is a timing chart according to another embodiment of the present invention.

FIG. 3 is an equivalent-circuit diagram according to another embodiment of the present invention.

FIG. 4A shows a configuration according to another embodiment of the present invention.

FIG. 4B shows a configuration according to another embodiment of the present invention.

FIG. 5A shows one of manufacturing steps according to another embodiment of the present invention.

FIG. 5B shows another one of the manufacturing steps.

FIG. 5C shows another one of the manufacturing steps.

FIG. 5D shows another one of the manufacturing steps.

FIG. 5E shows another one of the manufacturing steps.

FIG. 5F shows another one of the manufacturing steps.

FIG. 6 shows a configuration according to another embodiment of the present invention.

FIG. 7 shows the configuration of a comparable example.

### DESCRIPTION OF THE EMBODIMENTS

### First Embodiment

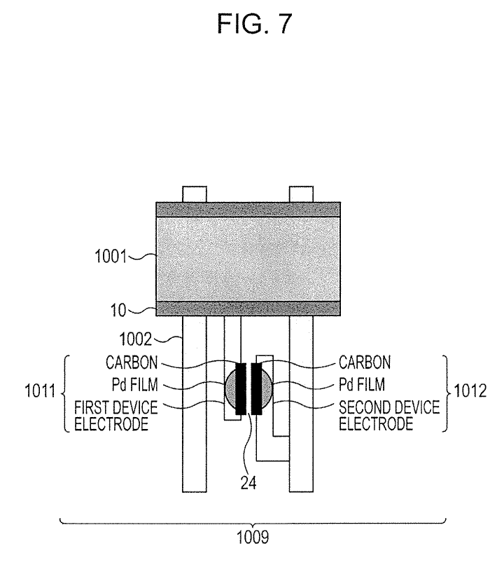

Hereinafter, an electron-emitting device according to a first embodiment of the present invention will be described. The above-described electron-emitting device is a device configured to emit an electron by applying a voltage between a first conductive member 1011 and a second conductive member 1012 that are opposed to each other with a gap 24 therebetween (provided with a distance therebetween), as shown in FIG. 7, for example. The electron-emitting device shown in FIG. 7 is a surface-conduction-electron-emitting device. The present invention can be used for various kinds of field emission type electron-emitting devices configured to apply a voltage between two conductive members so that an electron is emitted. The above-described field emission type electron-emitting devices include a Spindt-type emitter, a metal-insulator-metal (MIM)-type emitter, an emitter including carbon nanotubes, etc.

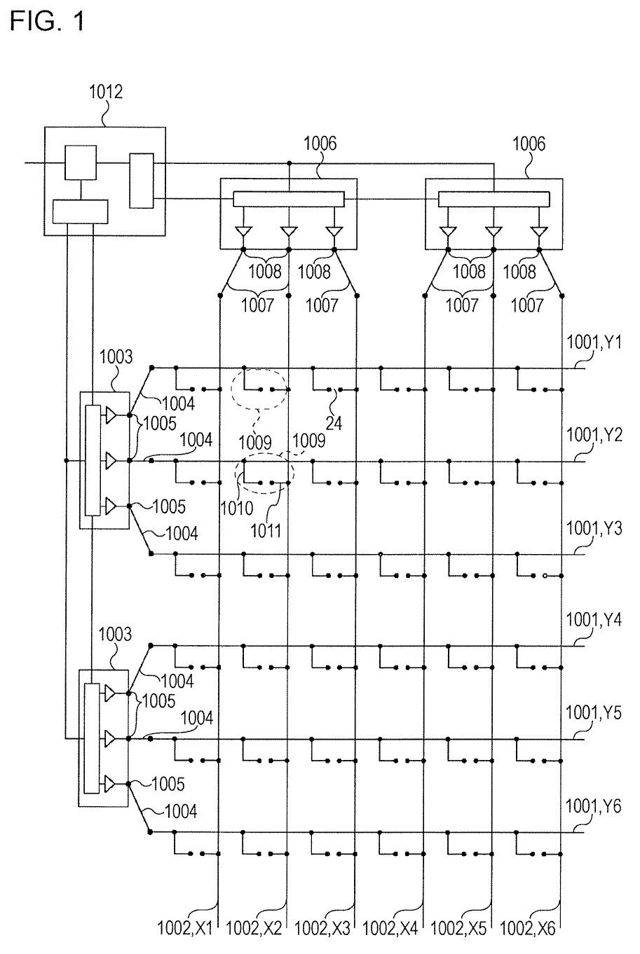

FIG. 1 shows the configuration of an electron source according to the first embodiment. In FIG. 1, the configuration of a 6×6 matrix is shown.

Plural scanning wirings 1001 (Y1, Y2, Y3, Y4, Y5, and Y6) and plural modulation wirings 1002 (X1, X2, X3, X4, X5, and X6) form a matrix wiring.

The scanning wirings 1001 are connected to output ends 1005 of first integrated circuits 1003, which in one example are scanning-side drivers, via connection wirings 1004.

The modulation wirings 1002 are connected to output ends 1008 of second integrated circuits 1006, which in one example are modulation-side drivers, via connection wirings 1007.

In the present example, each of the first integrated circuits 1003 and the second integrated circuits 1006 is an IC chip, and each of the connection wirings 1004 and the connection wirings 1007 is a flexible-print wiring, although those components are not limited to those examples only.

In the first embodiment, at least one electron-emitting device 1009 is a surface-conduction-electron-emitting device. The electron-emitting device 1009 includes a first conductive member 1010 and a second conductive member 1011 that are opposed to each other with a gap therebetween. Each conductive member 1010 is connected to a corresponding scanning wiring 1001 and each conductive member 1011 is connected to a corresponding modulation wiring 1002. Matrix connections are established between the electron-emitting devices 1009 through the scanning wirings 1001 and the modulation wirings 1002. Each electron-emitting device 1009 is matrix-driven due to a scan signal (selection signal) applied to the corresponding scanning wiring 1001 and a modulation signal applied to the corresponding modulation wiring 1002.

An image signal is input to a control circuit 1012 configured to output a timing signal and gray-scale data to the first integrated circuits 1003 and the second integrated circuits 1006.

Each first integrated circuit 1003 applies scan signals to the plural scanning wirings 1001 connected thereto, in sequence, as will now be described.

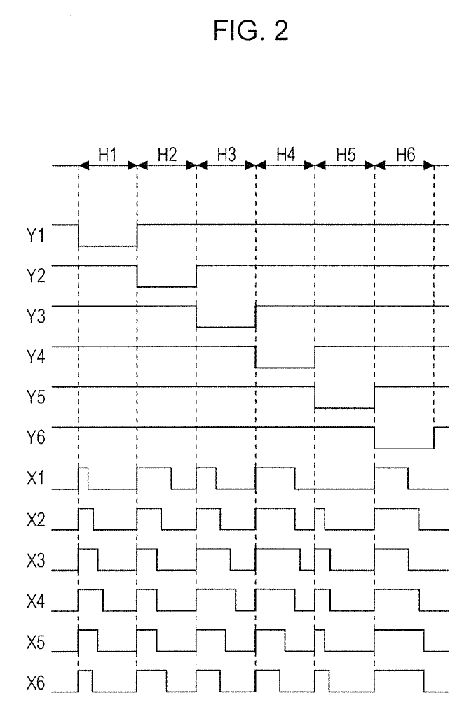

FIG. 2 shows a timing chart indicating how the scan signals are applied to the scanning wirings 1001.

Over a selection period H1, the scan signal is applied to the scanning wiring Y1, over selection period H2, the scan signal is applied to scanning wiring Y2, and so on, until selection period H6 in which the scan signal is applied to scanning wiring Y6.

The second integrated circuits 1006 output modulation signals in synchronization with the selection periods. For example, as shown in FIG. 2 in association with FIG. 1, over the selection period H1, the scan signal is applied to the scanning wiring Y1 and the plural electron-emitting devices connected to the scanning wiring, and, over the same selection period H1, the modulation signal is applied to each of the plural modulation wirings X1 to X6, thereby selecting corresponding ones of the electron-emitting devices. Since plural electron-emitting devices connected to the scanning wiring Y2 are selected during the selection period H2, and the modulation signal is applied to each of the plural modulation wirings X1 to X6, as indicated in FIG. 2, corresponding ones of the electron-emitting devices connected to wiring Y2 are selected.

Consequently, the modulation signals can be applied to the plural electron-emitting devices connected to the selected scanning wirings at one time via the plural modulation wirings X1 to X6.

The timing chart of FIG. 2 shows an example state where the modulation signals are applied to the modulation wirings X1 to X6. According to the above-described embodiment, a pulse-width-modulation signal is used as the modulation signal.

Thus, according to the above-described driving, the scanning wirings can be selected in sequence and the modulation signals can be simultaneously applied to the plural electron-emitting devices connected to the selected scanning wiring. The above-described driving is referred to as line-at-a-time driving.

During the line-at-a-time driving, currents as the maximum current may flow at one time into the scanning wiring to which the scan signal is applied, via all of the electron-emitting devices connected to the scanning wiring at the maximum. Therefore, the current-allowable value obtained at each of output ends of the first integrated circuits 1003 is determined or selected so that the current-allowable value can withstand the above-described large currents (above-described maximum current). On the other hand, even though currents are flown into the output ends of the second integrated circuits 1006 at one time, each of the currents is usually a current that would be flown into a single electron-emitting device. Although a driving method used to select plural scanning wirings at one time may be adopted, the number of scanning wirings selected at the same time is, at most, two or three. In that case, therefore, the maximum value of a current flown into each of the output ends of the second integrated circuits 1006 is smaller than that of a current flown into each of the output ends of the first integrated circuits 1003. Consequently, the current-allowable value obtained at each of the output ends of the second integrated circuits 1006 may be smaller than that obtained at each of the output ends of the first integrated circuits 1003. Likewise, the value of the resistance of the scanning wiring to which the first integrated circuit 1003 is connected may be smaller than that of the resistance of the modulation wiring to which the second integrated circuit is connected.

Thus, during the line-at-a-time driving, the current-allowable value of one of the output ends of the first integrated circuit connected to the scanning wiring is larger than that of one of the output ends of the second integrated circuit connected to the modulation wiring. In the above-described embodiment, the current-allowable value of each of the output ends of the first integrated circuit is larger than that of each of the output ends of the second integrated circuit. According to the above-described configuration, a current which flows due to the occurrence of a discharge may be appropriately flown to the first integrated circuit's side, where the first integrated circuit is connected to the scanning wiring.

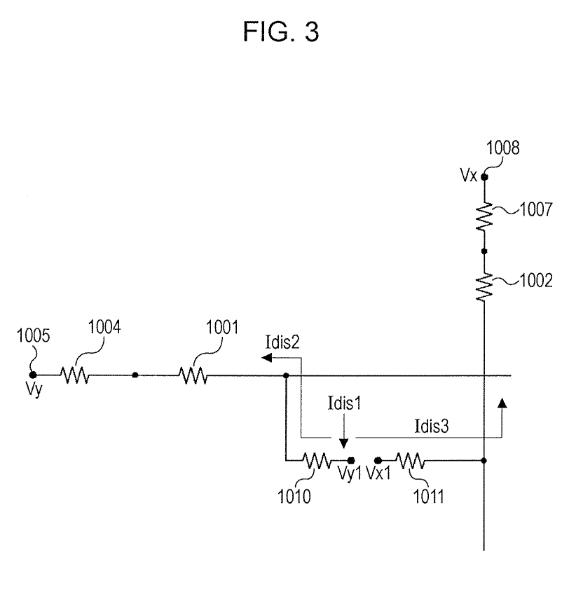

Here, an example where a discharge occurs between the first conductive member 1010 of an electron-emitting device 1009 and an anode opposed to the electron-emitting device 1009 will be considered with reference to FIG. 3.

A current Idis1 flown from the anode to the conductive member 1010 due to the discharge may be divided into a current Idis2 flown into the scanning wiring 1001 connected to the conductive member 1010 and a current Idis3 flown into the conductive member 1011 opposed to the conductive member 1010 with a gap therebetween.

Before the electron-emitting device 1009 is destroyed due to the above-described discharge, a short circuit occurs between the conductive members 1010 and 1011. When the short circuit occurs (when the electron-emitting device wherein the discharge occurs is destroyed), the ratio Ids3/Idis1 at which a discharge current is diverted to the conductive member 1011's side becomes larger than that attained when no short circuit occurs. Therefore, the ratio Idis3/Idis1 at which a discharge current is diverted to the conductive member 1011's side can be decreased by reducing the short circuit.

The following conditions should be satisfied to reduce the short circuit.

Each of the scanning wirings 1001, the connection wirings 1004 provided to connect the scanning wirings 1001 to the output ends 1005 of the first integrated circuits 1003, the first conductive members 1010, the second conductive members 1011, the modulation wirings 1002, the connection wirings 1007 provided to connect the modulation wirings 1002 to the output ends 1008 of the second integrated circuits 1006, has a resistance.

Here, a predetermined electron-emitting device will be described. The resistance of a region extending from part of a first conductive member 1010 of the predetermined electron-emitting device, the part facing the gap between the first and second conductive members 1010 and 1011, to the output end 1005 of the first integrated circuit 1003 via the respective scanning wirings 1001, is determined to be RU. Further, the resistance of a region extending from part of the second conductive member 1011 of the predetermined electron-emitting device, the part facing the gap between the first and second conductive members 1010 and 1011, to the output end 1008 of the second integrated circuit 1006 via the respective modulation wirings 1002, is determined to be RL.

The first integrated circuit 1003 generates a potential Vy at the output end corresponding to the scanning wiring 1001 connected to the electron-emitting device, where the potential Vy makes the scanning wiring 1001 enter a selection state. Then, the second integrated circuit 1006 generates a potential Vx at the output end 1008 corresponding to the modulation wiring 1002 connected to the electron-emitting device, where the above-described electron-emitting device should emit an electron. Here, when the second integrated circuit 1006 generates the potential at the output end 1008 connected to the modulation wiring 1002 connected to the electron-emitting device that should emit the electron, the potential has at least two values during the amplitude modulation. In that case, a potential used to emit light with the maximum level gray scale is determined to be Vx.

FIG. 3 is a schematic diagram showing the relationship between the above-described electron-emitting devices 1011 and 1010, the wirings 1001, 1002, 1004, and 1007 connected to the electron-emitting devices 1011 and 1010, the output ends 1005 and 1008 of the first and second integrated circuits 1003 (FIG. 1) and 1006 (FIG. 1) connected to the wirings 1001, 1002, 1004, and 1007, and the resistances.

If the potential attained at the part of the first conductive member 1010, the part facing the above-described gap, is determined to be Vy1, and the potential attained at the part of the second conductive member 1011, the part facing the above-described gap, is determined to be Vx1, the value of the difference between the potential Vy1 and the potential Vx1 should be equivalent to or less than Vmax indicating the allowable value of a voltage applied to the gap.

Here, the difference between the potential Vy of the output end 1005 of the first integrated circuit 1003 and the potential Vy1 attained at the part of the first conductive member, the part facing the gap, can be shown by the subtraction Vy1−Vy. Further, the resistance of the region extending from the output end 1005 of the first integrated circuit 1003 to the part of the first conductive member, the part facing the gap, is determined to be RU. First, a current passed between the output end 1005 and the part of the first conductive member, the part facing the gap, can be shown by the equation Idis2=Idis1−Idis3. Consequently, the equation Vy1−Vy=Idis2*RU holds by Ohm's law.

Likewise, the difference between the potential of the output end 1008 of the second integrated circuit 1006 and the potential attained at the part of the second conductive member 1011, the part facing the gap, can be shown by the subtraction Vx1−Vx. Further, the resistance of the region extending from the output end 1008 of the first integrated circuit 1006 to the part of the second conductive member 1011, the part facing the gap, is determined to be RL. Further, a current passed through the above-described region is determined to be Idis3. Consequently, the equation Vx1−Vx=Idis3*RL holds by Ohm's law.

When the subtraction Vy1−Vx1 is calculated based on the above-described two equations, the equation Vy1−Vx1=Idis2*RU−Idis3*RL+Vy−Vx holds.

Since the result of the subtraction Vy1−Vx1 should be equivalent to or less than Vmax, the equation Idis2*RU−Idis3*RL+Vy−Vx≦Vmax holds.

Here, the value Vmax is determined as below.

The value Vmax can be determined by applying the maximum potential that can satisfy requirements to normally drive an electron source and/or a display including the electron source to an anode and keeping the above-described state. If the potential applied to the anode is variable, the value Vmax can be determined by applying a potential which is the highest of all varied potentials to the anode and keeping the above-described state.

One of the plural electron-emitting devices provided in the electron source is selected and a ground potential is applied to the position where the output end 1005 of the first integrated circuit 1003 is provided, where the first integrated circuit 1003 corresponds to the scanning wiring connected to the selected electron-emitting device. Further, another ground potential is applied to the position where the output end 1008 of the second integrated circuit 1006 is provided, where the second integrated circuit 1006 corresponds to the modulation wiring 1002 connected to the selected electron-emitting device.

The value of the potential applied to the position where the output end 1005 of the first integrated circuit 1003 is provided is fixed to that of the ground potential and a pulse signal is applied to the position where the output end 1008 of the second integrated circuit 1006 is provided. For the above-described pulse signal, the ground potential is determined to be a reference potential, the maximum potential Vm is determined to be 0.1V, and the pulse width is determined to be 10 ns. In that case, the same pulse signal as the above-described pulse signal is applied, at the same time as when the above-described pulse signal is applied, at each of the positions where the output ends 1005 of the first integrated circuit 1003 provided for other scanning wirings are provided. Further, the ground potential is applied at each of the positions where the output ends 1008 of the second integrated circuit 1006 provided for other modulation wirings are provided.

A current which flows into the output end 1008 of the second integrated circuit 1006 is measured at the time when the pulse signal is applied, where the second integrated circuit 1006 corresponds to the modulation wiring 1002 connected to the selected electron-emitting device.

Next, after determining the maximum potential Vm to be 0.2V and leaving the pulse width unchanged, the pulse signal is applied and the step of measuring a current flowing into the output end 1008 of the second integrated circuit 1006 is performed.

While increasing the maximum potential Vm in steps of 0.1V, the steps of applying the pulse signal and measuring the current are performed in sequence. A nonoperating period provided between the above-described steps (the period after the pulse-signal application corresponding to the previous step is finished until the pulse-signal application corresponding to the next step is started) is determined to be a single second. The maximum potential Vm obtained at the step immediately preceding the step where the value of the measured current becomes one-hundredth of the value of a current obtained at the immediately preceding step is determined to be Vmax′ of the selected electron-emitting device. Further, the current measured at the immediately preceding step is determined to be Ifmax′ of the selected electron-emitting device.

Then, the subtraction Vmax′−Ifmax′*(RU+RL) is determined to be Vmax″ of the selected electron-emitting device.

Ten electron-emitting devices different from one another are selected and Vmax″ of each of the selected electron-emitting devices is determined.

The simple average of the values Vmax″ of the above-described ten selected electron-emitting devices is determined to be Vmax shared by the electron-emitting devices of the above-described electron source. The resistance RL and the resistance RU are determined according to the following method.

After measuring each of the above-described values Vmax′ and Ifmax′ (and after measuring Idis2, Idis3, etc. that will be described later, where the measurement is performed before division), the electron source is divided into a substrate on which the electron-emitting devices 1009 and the matrix wiring are provided and an anode.

A probe is applied to each of a position near the part of the first conductive member of the electron-emitting device to be measured, the part facing the gap, and the output end 1005 of the first integrated circuit 1003 so that a resistance between the probes is measured. After moving the probes away from the part facing the gap and the output end 1005, the probe is applied to each of the position near the part of the first conductive member, the part facing the gap, and the output end 1005 of the first integrated circuit 1003 again so that the resistance between the probes is measured. The above-described steps are repeated ten times for the same subject to be measured and the simple average of the values of the measured resistances is determined to be the resistance RU of the electron-emitting device to be measured. The resistance RL of the above-described electron-emitting device is determined in the same manner. Namely, a probe is applied to each of a position near the part of the second conductive member, the part facing the gap, and the output end 1008 of the second integrated circuit 1006 so that a resistance between the probes is measured. The simple average of results of the above-described steps repeated ten times for the same subject to be measured is determined to be the resistance RL. Thus, the resistances RU and RL are determined by performing the above-described steps for each of the electron-emitting devices for which the resistance RU is measured and the electron-emitting devices for which the resistance RL is measured.

The values Idis2 and Idis3 are determined as below.

The maximum potential which can be attained while satisfying the requirements to normally drive the electron source and/or the display including the electron source is applied to the anode and the state obtained by performing the above-described step is maintained. If the potential applied to the anode is variable, a potential which is the highest of all varied potentials is applied to the anode and the state obtained by performing the above-described step is maintained.

The ground potential is applied to each of the output ends 1005 of the first integrated circuits 1003 and each of the output ends 1008 of the second integrated circuits 1006.

After that, the selected electron-emitting device is irradiated with laser light. By being irradiated with the laser light, the electron-emitting device is caused to discharge at the position where the laser irradiation is performed. According to the above-described embodiment, the term “discharge” is different from an ordinary electron discharge achieved by an electron-emitting device when an electron source is normally driven.

According to the above-described embodiment, the discharge is attained as below. First, a scan signal is applied from the output end 1005 of the first integrated circuit 1003 to a single scanning wiring 1001 only, no scan signal is applied from the first integrated circuit 1003 to other scanning wirings and a potential is applied to each of the other scanning wirings so that the other scanning wirings enter a non-selection state, and when a modulation signal of the maximum gray scale which can be attained during normal driving is applied from the second integrated circuit 1006 to a single modulation wiring 1002 only, a current flowing into the output end 1005 of the first integrated circuit 1003 provided for the single scanning wiring 1001 to which the scan signal is applied is determined to be I1. Then, a current equivalent to and/or larger than 10*I1 is passed to the output end 1005 of the first integrated circuit 1003 provided for the single scanning wiring 1001 so that the above-described discharge is attained.

The inventor of the present invention confirms that the above-described discharge occurs by performing the laser irradiation. The above-described discharge may be considered to be practically the same as a discharge (short circuit) which occurs between an anode and an electron-emitting device while an electron source and/or a display including the electron source is driven under normal conditions.

When the above-described discharge occurs, the maximum value of a current flowing to the position where the output end 1005 of the first integrated circuit 1003 is provided is determined to be Idis2, where the first integrated circuit 1003 corresponds to the scanning wiring 1001 connected to the selected electron-emitting device. On the other hand, when the above-described discharge occurs, the maximum value of a current flowing to the position where the output end 1008 of the second integrated circuit 1006 is provided is determined to be Idis3, where the second integrated circuit 1008 corresponds to the modulation wiring 1002 connected to the selected electron-emitting device.

According to embodiments of the present invention, the sign * indicates integration.

The values Idis2, RU, Idis3, RL, Vmax that are determined in the above-described manner should satisfy the above-described condition indicated by the inequality Idis2*RU−Idis3*RL+Vy−Vx≦Vmax.

Preferably, all of the electron-emitting devices satisfy the above-described condition.

Hereinafter, an example detailed configuration of an electron source satisfying the above-described conditions and an example method of manufacturing the electron source will be described, as a second embodiment of the present invention.

### Second Embodiment

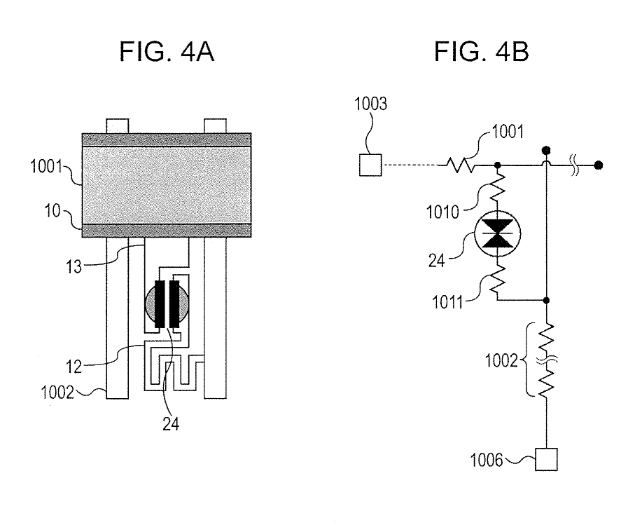

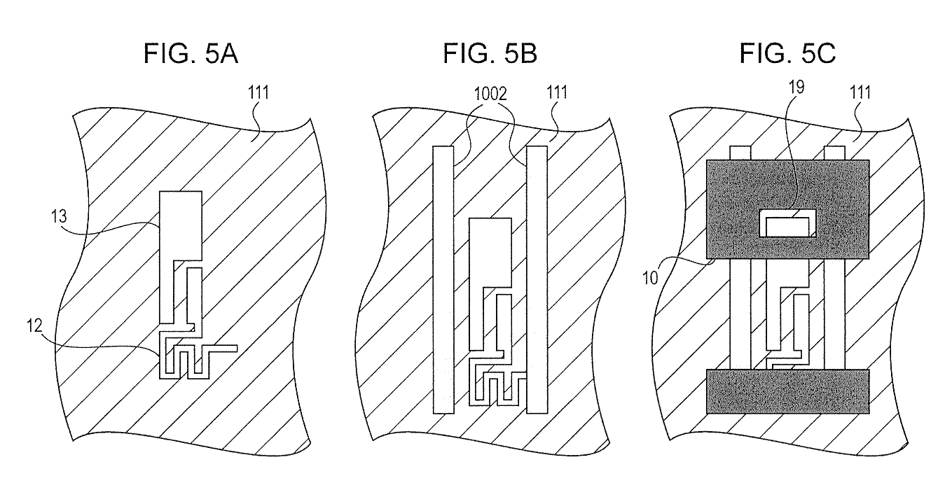

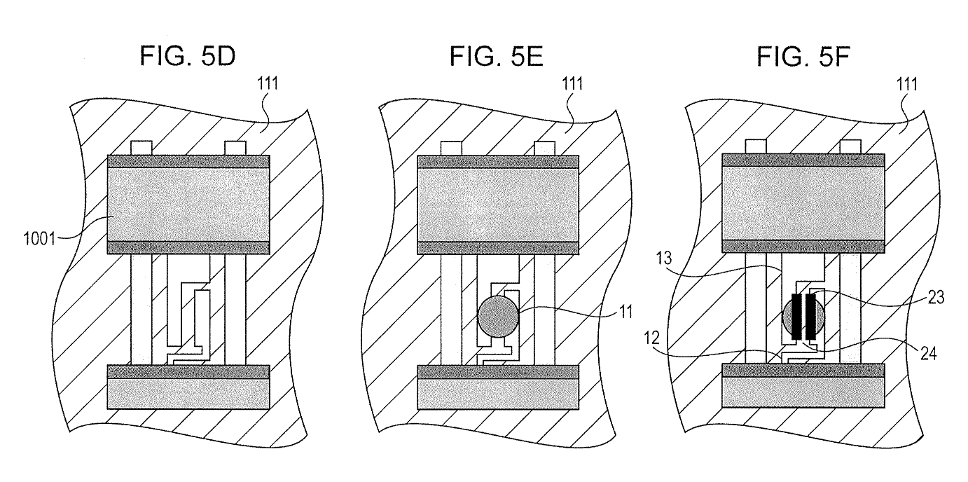

FIG. 4A is a schematic diagram showing the configuration of each of the first and second conductive members according to the second embodiment. FIG. 4B is an equivalent-circuit diagram of the above-described configuration. Further, FIGS. 5A, 5B, 5C, 5D, 5E, and 5F show the steps of manufacturing the configuration shown in FIG. 4A.

According to the second embodiment, a glass substrate 111 that has a thickness of 2.8 mm and that includes PD-200 (manufactured by ASAHI GLASS CO., LTD) containing few alkali components is prepared. Further, an SiO2 film having a thickness of 100 nm is applied and baked on the above-described glass substrate 111, as a sodium-block layer. After that, the glass substrate 111 is used as a substrate used to achieve the electron source.

### [Formation of Device Electrode]

First, as shown in FIG. 5A, a first device electrode 13 and a second device electrode 12 are provided on the above-described substrate. Each of the device electrodes 13 and 12 is formed by performing the sputtering method. First, a Ti film is formed as an undercoat layer and a Pt film having a thickness of 20 nm is formed on the Ti film. After that, patterning is performed according to a photolithography method so that the first and second device electrodes 13 and 12 are obtained. The photolithography method includes a series of steps of applying photoresist on the entire face of the Pt film, performing an exposure, performing development, and performing etching.

At that time, the first device electrode 13 is configured so that the width thereof is larger than that of the second device electrode 12 of the second conductive member. Consequently, the cross-sectional area of the first device electrode 13 is increased and the resistance obtained over a region extending from a signal wiring that will be described later to the gap is decreased. On the other hand, the second device electrode 12 is longer than the first device electrode 13 of the first conductive member so that a resistance obtained over a region extending from a modulation wiring that will be described later to the gap is increased.

As a comparable example, FIG. 7 shows an electron-emitting device formed on part of the electron-source substrate, where the electron-emitting device has the shape of a device electrode. In the above-described comparable example, the value of the resistance of the first device electrode is almost the same as that of the resistance of the second device electrode.

### [Formation of Modulation Wiring]

During the pattern formation performed for the modulation wirings 1002 shown in FIG. 5B, a photopaste ink including silver is made into patterns. After being screen-printed, the photopaste ink is dried. Then, the photopaste ink is exposed and developed into a predetermined pattern. After that, the predetermined pattern is baked at a temperature of 480° C. so that the wiring is formed. Each of the modulation wirings 1002 has a thickness of about 10 μm and a width of 20 μm.

### [Formation of Interlayer-Insulation Layer]

As shown in FIG. 5C, an interlayer-insulation layer 10 is provided so that the modulation wirings 1002 are insulated from the scanning wiring 1001 to be formed over the modulation wirings 1002, where the scanning wiring 1001 will be described later. The above-described interlayer-insulation layer 10 is formed by making a contact hole 19 in a connection part and provided under the scanning wiring 1001 that will be described later. Consequently, the interlayer-insulation layer 10 covers the part where the scanning wiring 1001 and the previously formed modulation wirings 1002 cross each other, and the scanning wiring 1001 and the first device electrode 13 can be electrically connected to each other. For forming the above-described interlayer-insulation layer 10, a photosensitive glass paste including PbO as its main component is screen-printed, and exposed and developed. Finally, the glass paste is baked at a temperature of about 460° C.

### [Formation of Scanning Wiring]

The scanning wiring 1001 is formed on the interlayer-insulation layer 10 formed in advance, as shown in FIG. 5D. For forming the scanning wiring 1001, a paste ink including silver is screen-printed, dried, and baked at a temperature in the neighborhood of 450° C.

### [Formation of Pd Film]

After cleaning the substrate having the above-described matrix wiring sufficiently, the surface of the substrate is processed by using a solution including a repellent so that the surface becomes hydrophobic so that a water solution that is used to form a Pd film and that is applied on the surface later on is appropriately spread on the device electrodes. After that, a Pd film 11 is formed between the device electrodes according to an inkjet-printing method, as shown in FIG. 5E. After that, the above-described substrate is heated and baked, in the air, at a temperature of 350° C. over the period of ten minutes to convert film 11 to a palladium oxide (PdO) film. By performing the above-described steps, the palladium oxide (PdO) film, that is, a conductive thin film is formed on the part where the first and second device electrodes are provided.

### [Forming]

At the next step of performing forming, the entire substrate is covered by using a hood-like lid so that a space containing H2 gas is formed between the substrate and the lid, a voltage is applied from an external power source between the scanning wiring and the modulation wiring through the electrode ends so that a current is passed between the device electrodes 13 and 12. Through the above-described current passage, the PdO film is changed into Pd film and then the Pd film 11 is locally destroyed, deformed, or altered so that a gap highly resistant to electricity is formed.

### [Activation—Carbon Accumulation]

If the substrate is merely subjected to the above-described forming, the degree of the electron-generation efficiency is significantly low. Therefore, it is preferable that processing referred to as activation be performed for the above-described device, so as to increase the efficiency of emitting electrons.

According to the activation processing, the entire substrate is covered by using the hood-like lid, as is the case with the above-described forming processing, in a vacuum degree adequate to allow the presence of organic compounds so that a vacuum space is formed between the substrate and the lid. After that, pulse voltages are externally applied to the device electrodes repeatedly via a wiring electrode. Then, gas including atoms of carbon is introduced, and carbon and/or a carbon compounds derived from the gas are accumulated near a crack, as a carbon film. In the above-described activation step, for example, tolunitrile used as the carbon source is introduced in the vacuum space through a slow-leak valve and the state indicated by the multiplication 1.3×10⁻⁴ Pa is maintained. A gap 24 is formed between a carbon film 23 connected to the first device electrode 13 and that connected to the second device electrode 12, as shown in FIG. 5F.

An electron-source substrate can be manufactured by performing the above-described steps.

The first and second device electrodes 13 and 12, the Pd film 11, and carbon film 23 that are formed in the above-described manner are collectively referred to as the first and second conductive members. Of the conductive members provided with the gap 24 therebetween, the first conductive member is connected to the scanning wirings and the second conductive member is connected to the modulation wirings. The first and second conductive members and the gap 24 are collectively referred to as electron-emitting device 1009.

### [Seal-Bonding—Panelization]

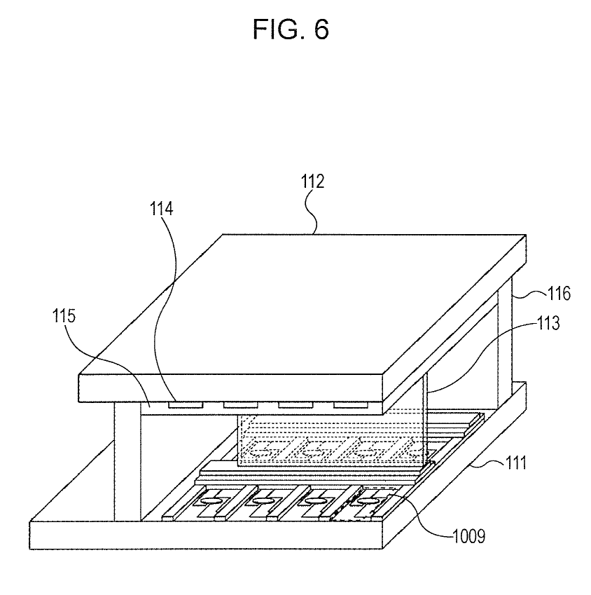

The above-described simple-matrix electron source and an example image-display apparatus used to display data or the like will be described. FIG. 6 shows the schematic configuration of an example image-display apparatus including the above-described electron source. FIG. 6 shows an electron source 111 provided with plural electron-emitting devices 1009 thereon.

An anode 112 includes a glass substrate, where a fluorescent film 114 which is a light-emitting member, a metalback 115, etc. are provided on the underface of the glass substrate. A support frame 116 is also provided. The anode 112 is provided at a position distant from the electron source through the use of the support frame 116 and a spacer. The electron source 111, the support frame 116, and the anode 112 are bonded to one another by using flit glass and baked over the period of at least ten minutes at a temperature of from 400° C. to 500° C. As a result, the electron source 111, the support frame 116, and the anode 112 are seal-bonded to one another so that an envelope is achieved.

According to the above-described manufacturing steps, the electron-emitting devices 1009 are formed on the electron source 111. The signal wiring and the modulation wiring are connected to a pair of device electrodes of the electron-emitting device 1009. A support member referred to as a spacer 113 is provided between the anode 112 and the electron source 111 so that the envelope becomes sufficiently strong under atmospheric pressure in the case where a large-area panel is used.

When the fluorescent film functioning as the light-emitting member is irradiated with electrons emitted from the electron-emitting device, light emission occurs so that an image is displayed.

### [Image-Display-Apparatus-Driving System]

Hereinafter, the outline of conditions for driving an image-display apparatus including the electron-source substrate according to the above-described embodiment will be described.

If a voltage-modulation method is performed in the above-described embodiment, a circuit configured to modulate the height value (amplitude) of a pulse signal based on transmitted data is used as the second integrated circuit 1006. Further, when a pulse-width-modulation method is performed, a circuit configured to modulate the time width of a voltage-pulse signal based on transmitted data is used as the second integrated circuit 1006. In either case, considering a voltage drop caused by a resistance device, the apparatus should be configured so that a voltage value which is 1.1 to 1.2 times as large as a desired voltage value to be applied to the electron-emitting device occurs between the output end of the first integrated circuit and that of the second integrated circuit. According to the above-described embodiment, the value Vy is determined to be −13V, and the value Vx is determined to be 5V.

In the above-described image-display apparatus, a voltage is applied to each of the electron-emitting devices via wirings provided in a display panel so that electrons are emitted. A high voltage is applied to the metalback 115, a generated electron beam is accelerated so that the generated electron beam collides with the fluorescent film 114. Consequently, an image can be displayed.

### [Measurement of Vmax]

Of components of the electron-emitting device 1009 formed in the above-described manner, a voltage is applied from each of the integrated circuits to the gap 24 which is the closest to the first integrated circuit 1003 and the farthest to the second integrated circuit 1006, and a current-to-voltage characteristic is measured. At the step where a potential difference of 30.4V is applied based on the above-described measurement method, the current value becomes equivalent to or less than one-hundredth of the value of a current obtained at the immediately preceding step. Namely, the value Vmax′ obtained in the above-described embodiment is 30.3V. The value Ifmax′ obtained at that time is 0.005 A. On the other hand, according to the comparable example, the value Vmax′ is 21.8V and the value Ifmax′ is 0.005 A.

### [Discharge Experiment]

Next, an experiment is performed by using laser light as the trigger of a discharge, so as to confirm the effect of the image-display apparatus of the above-described embodiment. First, a voltage of 3 KV is applied to the anode 112 of the image-display apparatus of the above-described embodiment and the comparable example. A voltage of −13V is generated at the output end of the first integrated circuit and a voltage of +5V is generated at the output end of the second integrated circuit and the image-display apparatus is driven under normal conditions. For the above-described system, the voltage and the current waveform of a voltage-application line are monitored by using a voltage probe and a current probe. The above-described system is irradiated, from a rear plate, with an yttrium aluminum garnet (YAG) laser light of which spot diameter is reduced to 10 μm. Consequently, part of the first device electrode 13 is melted so that a discharge is induced.

According to the above-described embodiment, most of discharge currents flows to the scanning wiring 1001's side and the maximum value Idis2 thereof is 1 A. On the other hand, the maximum value Idis3 of the discharge currents flowing from the modulation wiring 1002's side is 20 mA.

According to the comparable example, the maximum value Idis2 of the discharge currents, where most of the discharge current flows to the scanning wiring 1001's side, is 1 A. On the other hand, the maximum value Idis3 of the discharge current flowing from the modulation wiring 1002's side is 100 mA.

According to the image-display apparatus of the above-described embodiment, observing each of the device electrodes through an optical microscope after finishing the discharge experiment reveals that the electron-emitting device irradiated with the laser light is damaged. However, electron-emitting devices other than the above-described electron-emitting device are not damaged. On the other hand, according to the comparable example, electron-emitting devices provided along the modulation wiring 1002 are damaged even though they are not irradiated with the laser light.

### [Resistance Measurement]

After being subjected to the discharge experiment, the electron source is divided into the substrate on which the electron-emitting devices and the matrix wiring are provided, and the anode, and every resistance value is measured by using the same probe. In the case where no discharge experiment is performed, the resistance RU obtained over the region extending from the gap 24 that is provided in the electron-emitting device 1009 and that shows the smallest resistance value to the first integrated circuit 1003 via the first conductive member 1010 and the scanning wiring 1001 is 50Ω. Further, the resistance RL obtained over the region extending from the gap 24 provided in the same electron-emitting device 1009 to the second integrated circuit 1006 via the second device electrode 12 and the modulation wiring 1002 is 2000Ω. On the other hand, according to the electron-emitting device shown in the comparable example, the resistance RU is 100Ω and the resistance RL is 250Ω.

Further, according to the above-described embodiment, the value Vmax is determined to be 20V. On the other hand, the value Vmax is 20V in the comparable example.

Namely, the expression Idis2*RU−Idis3*RL+Vy−Vx can be expressed as the equation 1 A*50Ω−20 mA*2000+(−13V)−5V=8V satisfying the inequality Idis2*RU−Idis3*RL+Vy−Vx≦Vmax.

On the other hand, in the comparable example, the expression Idis2*RU−Idis3*RL+Vy−Vx can be expressed as the equation 1 A*100Ω−100 mA*250+(−13V)−5V=57V which does not satisfy the inequality Idis2*RU−Idis3*RL+Vy−Vx≦Vmax.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-156389 filed on Jun. 13, 2007, which is hereby incorporated by reference herein in its entirety.

What is claimed is:

1. An electron source comprising:
(A) plural electron-emitting devices, where each of the electron-emitting devices includes a first conductive member and a second conductive member that are opposed to each other with a gap therebetween;
(B) plural scanning wirings connected to the first conductive members, respectively;
(C) plural modulation wirings, where each of the modulation wirings crosses a corresponding scanning wiring and where the modulation wirings are connected to the second conductive members, respectively;
(D) a first integrated circuit which applies a scan signal to the scanning wirings, so as to perform line-at-a-time driving for the electron-emitting devices;
(E) a second integrated circuit which applies a modulation signal to the modulation wirings, so as to perform line-at-a-time driving for the electron-emitting devices; and
(F) an anode which is provided at a predetermined distance from the electron-emitting devices,
wherein when a resistance of a region extending from part of a first conductive member facing the gap, to an output end of the first integrated circuit via a corresponding scanning wiring is RU,
a resistance of a region extending from part of the second conductive member facing the gap, to an output end of the second integrated circuit via a corresponding modulation wiring is RL,
a voltage applied between the first conductive member and the second conductive member is Vmax,
the first integrated circuit generates a potential Vy at an output end thereof connected to a selected scanning wiring,
the second integrated circuit generates a potential Vx at an output end thereof connected to a modulation wiring connected to an electron-emitting device to emit an electron, and
a maximum value of a current which flows at a position of the output end of the first integrated circuit is Idis2 and a maximum value of a current which flows at a position of the output end of the second integrated circuit is Idis3 when a discharge occurs between the electron-emitting device and the anode,
the electron source satisfies the expression Idis2*RU−Idis3*RL+Vy−Vx≦Vmax.

2. The electron source according to claim 1, wherein the value Vmax is a value of a voltage applied between a potential obtained at the part of the first conductive member facing the gap, and a voltage obtained at the part of the second conductive member facing the gap.

3. An image-display apparatus including the electron source according to claim 1 and a light-emitting member which emits light by being irradiated with an electron emitted from at least one of the electron-emitting devices.

4. An image-display apparatus including the electron source according to claim 2 and a light-emitting member which emits light by being irradiated with an electron emitted from at least one of the electron-emitting devices.
